(19) United States
(12) Patent Application Publication
(10) Pub. No.: US 2007/0025749 A1
(43) Pub. Date: Feb. 1, 2007

(54) Transfer control unit of an image forming apparatus

(76) Inventor: Masato Kubota, Ibaraki (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/437,174

(22) Filed: May 19, 2006

(30) Foreign Application Priority Data
May 19, 2005 (JP) 2005-147311

(51) Int. Cl. G03G 15/16

(52) U.S. Cl. 399/66

(57) ABSTRACT

A transfer control unit of image forming apparatus is structured such that any one of the computation formulae each allocated to every range of each use environment divided by threshold voltages Vw established in advance corresponding to use environments is selected, representative values Vspa1, Vspa2, and Vspa0 of sampling voltages Vsp of a contact transfer member are determined, and a transfer bias compatible with a use environment at the current time is output from a transfer bias applying unit based on the representative values Vspa1, Vspa2, or Vspa0, thereby obtaining any one of the representative values Vspa1, Vspa2, and Vspa0 of the sampling voltage Vsp in conditions highly compatible with a use environment at the current time to carry out good transfer operation in either use environment of high temperature and high humidity or low temperature and low humidity.

### FIELD OF THE INVENTION

The present invention relates to a transfer control unit of image forming apparatus that allows an output of a transfer bias compatible with a use environment with respect to a contact transfer member arranged so as to come in contact with an image carrier such as photosensitive drum.

### DESCRIPTION OF THE RELATED ART

### Background of the Invention

Generally, in various image forming apparatuses such as electrographic photocopier and printer, for example, as shown in FIG. 9, the surface of a photosensitive drum 1 as an image carrier is uniformly charged by a primary charging bias applied by a charging roller 2, followed by forming an electrostatic latent image by an information modulated light 4 emitted from a light writing unit 3 in a spot form while being horizontally scanned. The electrostatic latent image on the photosensitive drum 1 is developed by means of toner supplied from a developing device 5 to make the image visible, thereby forming the obtained toner image on the photosensitive drum 1. In the transfer area of the photosensitive drum 1, a transfer roller 6 as a contact transfer member is arranged in contact with the photosensitive drum 1 so as to form a nip unit. By applying an appropriate transfer bias from a power unit not shown to the transfer roller 6 as the contact transfer member for the drum, the toner image formed on the photosensitive drum 1 is electrostatically transferred onto an appropriate sheet of recording paper P delivered from a paper feeder 7.

Here, an electric resistance value of the transfer roller 6 is easily affected by the use environment, which gives rise to a problem that the transfer bias tends to become unstable. In particular, an ion conductive transfer roller that has often been employed in recent years, that is, a transfer roller provided with a rubber elastic layer having ion conductivity on the outer peripheral surface of the conductive core of the roller has an advantage that there is little materialistic variation, whereas the electric resistance value is very easily affected particularly by environmental humidity. In view of such a background, for example, in the following patent document and the like, development and proposition of transfer control device for optimization of a transfer bias voltage that is called as active transfer voltage control (ATVC) device have been conducted (for example, refer to Patent document 1).

Although a detailed explanation of the structure of this transfer control device is omitted, this transfer control device is structured so as to appropriately control the power unit for the transfer bias corresponding to a use environment at the current time by operation of the central processing unit (CPU). This transfer control device is structured such that, for example, a desired detection current is passed onto the side of the photosensitive drum through the transfer roller 6 in a state with no paper such as during preliminary rotation in an image forming process, a voltage value generated at this time is measured by means of a transfer member resistance detection unit, thereby not only detecting the electric resistance value of the transfer roller 6 at the current time but also optimizing a detection signal output from the transfer member resistance detection unit, that is, a voltage of the transfer bias described above based on the measured electric resistance value of the transfer roller 6, and the transfer bias controlled by the voltage having been optimized is applied to the transfer roller 6 at the time of transfer in the image forming process.

However, it is often the case that with respect to the transfer roller 6, irregularity is generated in the electric resistance distribution in the longitudinal direction or along the peripheral direction. Because of this, in the transfer control device, for example, as shown in FIG. 10, sampling voltages Vsp (vertical axis) vary minutely with a lapse of time (horizontal axis) to generate variation. Accordingly, a conventional transfer control device is structured such that an average value Vave of a number of sampling voltages Vsp is computed and used as a representative value, a transfer bias compatible with a use environment at the current time is determined by using the average detected voltage Vave as its representative value for a data table or the like, and the transfer bias is output from the power unit serving as a transfer bias applying unit.

However, when an output from the transfer bias applying unit is determined based on the average detected voltage Vave, a peak value in the variation range of the sampling voltages Vsp has a value apart from the average detected voltage Vave, and therefore, it is sometimes the case that good transfer operation is not carried out depending on the environment. That is, even though there is a variation in the sampling voltages Vsp under a usual use environment of normal temperature and normal humidity, a transfer bias determined based on the average detected voltage Vave does not deviate from the good transfer range. However, when the environment becomes a severe environment of high temperature and high humidity or of low temperature and low humidity as shown, for example, in FIG. 11 or FIG. 12, portions (shaded portions) where the transfer bias determined based on the average detected voltage Vave falls sometimes outside the good transfer range generates in one side portion of the variation range of the sampling voltages Vsp, and a transfer defect occurs in the portions outside the good transfer range.

In a more detailed explanation, under the use environment of high temperature and high humidity (for example, 32 degrees C. and 60% or higher humidity) shown in FIG. 11, the electric resistance of the transfer roller 6 decreases, which also leads to a decrease in the applied voltage necessary for passing a constant current to the transfer roller 6. Owing to this, the sampling voltages Vsp also decrease to make their average detected voltage Vave low as well. Therefore, when the degree of high temperature and high humidity becomes larger and the average detected voltage Vave becomes lower drastically, the portions (shaded portions) under the average detected voltage Vave starts to become lower than the lower limit value of the range in which good transfer operation is carried out. In each lowered portion, toner on the photosensitive drum side does not come to be transferred onto the recording paper side, which gives rise to generation of so-called defect of transferred colorant and the like.

On the other hand, under the use environment of low temperature and low humidity (for example, 15 degrees C., 10% or lower humidity) shown in FIG. 12, the electric resistance of the transfer roller 6 increases, which leads to an increase of the sampling voltages Vsp, as well as an increase of their average detected voltage Vave. When the degree of low temperature and low humidity becomes larger and the average detected voltage Vave becomes higher drastically, the portions (shaded portions) above the average detected voltage Vave starts to become higher than the higher limit value of the range in which good transfer operation is carried out. In the portions (shaded portions) that are above the higher limit value, the current flows to the photosensitive drum side by a short current, which also gives rise to generation of a similar transfer defect.

(Patent document 1)

Japanese Patent Application Laid-Open Publication No. 1990-123385

### SUMMARY OF THE INVENTION

An object of the present invention is to provide a transfer control unit of image forming apparatus capable of carrying out good control operation of transfer bias in conditions more compatible with a use environment.

In order to achieve the above object, the transfer control unit of image forming apparatus according to claim 1 of the present invention comprises an image carrier that retains a toner image formed after development, a contact transfer member that is arranged so as to come in contact with a transfer area of the image carrier, a transfer bias applying unit that allows the toner image on the image carrier to be transferred onto the recording paper side by applying a transfer bias to the contact transfer member, and a transfer control device that computes an average value of a plurality of sampling voltages obtained by passing a constant detection current to the contact transfer member and allows an output of a transfer bias compatible with a use environment at the current time from the transfer bias applying unit based on the average detected voltage, where the transfer control device is structured such that an average detected voltage of all sampling voltages is employed as a representative value under a constant use environment, whereas an average detected voltage of limited sampling voltages is employed as a representative value under another use environment that deviates from the constant use environment, and the transfer bias applying unit outputs a transfer bias determined based on the representative value employed.

According to the transfer control unit of image forming apparatus having such a structure according to claim 1 of the present invention, when a high temperature and high humidity or a low temperature and low humidity of a use environment is detected, a representative value compatible with the use environment detected is employed, and a transfer bias value is determined and output based on the representative value corresponding to the use environment, and therefore, good transfer operation can be carried out in either case of a high temperature and high humidity or a low temperature and low humidity.

Further, in the transfer control unit of image forming apparatus according to claim 2 of the present invention, the transfer control device in claim 1 is structured such that the average detected voltage of all the sampling voltages is compared with threshold voltages established in advance corresponding to use environments and the use environment is judged based on the comparison results.

According to the transfer control unit of image forming apparatus having such a structure according to claim 2, a use environment is detected satisfactorily and quickly even though the average detected voltage Vave of all the sampling voltages Vsp obtained by passing a constant detection current to the contact transfer member deviates from the range of threshold voltages Vw.

Furthermore, in the transfer control unit of image forming apparatus according to claim 3 of the present invention, the transfer control device in claim 1 is structured such that the plurality of sampling voltage values Vsp are obtained by passing a constant detection current to the contact transfer member in a state of no recording paper or during feeding paper with respect to the contact transfer member.

According to the transfer control unit of image forming apparatus having such a structure according to claim 3, detection operation of resistance value of the contact transfer member is carried out smoothly without giving any disturbance to the image forming operation.

Still further, in the transfer control unit of image forming apparatus according to claim 4 of the present invention, the transfer control device in claim 1 is structured such that sampling of voltage with respect to the contact transfer member is carried out over one or more rounds of the contact transfer member.

According to the transfer control unit of image forming apparatus having such a structure according to claim 4, detection operation with respect to the contact transfer member is carried out for over the entire round, and therefore, transfer control operation with higher accuracy is carried out.

Still further, in the transfer control unit of image forming apparatus according to claim 5 of the present invention, a first threshold voltage Vw1 corresponding to the lower limit voltage of a use environment of high temperature and high humidity and a second threshold voltage Vw2 corresponding to the upper limit voltage of a use environment of low temperature and low humidity are established as threshold voltages Vw in the transfer control device in claim 2.

According to the transfer control unit of image forming apparatus having such a structure according to claim 5, the region between the first threshold voltage Vw1 and the second threshold voltage Vw2 is established in the range of ordinary normal temperature and normal humidity, and therefore, transfer control operation with higher accuracy is carried out.

Still further, in the transfer control unit of image forming apparatus according to claim 6 of the present invention, a computation formula for high temperature and high humidity by which an average value of an arbitrary number n of the sampling voltages selected from the lowest voltage Vspmin of the plurality of sampling voltages Vsp in ascending order is computed as a representative value Vspa1 when the average detected voltage Vave is lower than the first threshold voltage Vw1; another computation formula for low temperature and low humidity by which an average value of an arbitrary number n of the sampling voltages selected from the highest voltage Vspmax of the plurality of sampling voltages Vsp in descending order is computed as a representative value Vspa2 when the average detected voltage Vave is higher than the second threshold voltage Vw2; and still another computation formula for environment of normal temperature and normal humidity by which an average value of all the plurality of sampling voltages Vsp is computed as a representative value Vspa0 when the average detected voltage Vave falls between the first threshold voltage Vw1 and the second threshold voltage Vw2 are provided as the computation formulae to the transfer control device in claim 5.

According to the transfer control unit of the image forming apparatus having such a structure according to claim 6, when a use environment lies within the range of normal temperature and normal humidity, in a manner similar to the conventional manner, a transfer bias is determined based on the average detected Vave of the plurality of sampling voltages Vsp. When a use environment falls in conditions of a high temperature and a high humidity, the whole of the sampling voltages Vsp falls, and therefore, the representative value Vspa1 of the plurality of sampling voltages Vsp is computed so as to take a value lower than the common average detected voltage Vave with the use of the computation formula for high temperature and high humidity corresponding to the use environment, thereby preventing a transfer defect in portions with excessive drop in the sampling voltages Vsp.

On the contrary, when a use environment falls in conditions of a low temperature and a low humidity, the whole of the sampling voltages Vsp rises, and therefore, the representative value Vspa1 of the plurality of sampling voltages Vsp is computed so as to take a value higher than the common average detected voltage Vave with the use of the computation formula for low temperature and low humidity corresponding to the use environment, thereby preventing a transfer defect in portions with excessive rise in the sampling voltages Vsp.

### BRIEF DESCRIPTION OF THE DRAWINGS

FIG. 1 is a detailed diagram to explain a vertical cross sectional view that represents an example of an entire structure of a laser printer as one example of an image forming apparatus applied with the present invention;

FIG. 2 is a block diagram that represents a control unit of a transfer bias applying unit in one embodiment of the present invention that is used in the laser printer shown in FIG. 1;

FIG. 3 is a schematic diagram that represents a variation of sampling voltages when a use environment of the unit according to the present invention is in conditions of a normal temperature and a normal humidity;

FIG. 4 is a schematic diagram that represents a variation of the sampling voltages when a use environment of the unit according to the present invention is in conditions of a high temperature and a high humidity;

FIG. 5 is a schematic diagram that represents a variation of the sampling voltages when a use environment of the unit according to the present invention is in conditions of a low temperature and a low humidity;

FIG. 6 is a diagram that represents one example of a control table that is used when a transfer bias is determined based on a representative value of the sampling voltages;

FIG. 7 is a flow chart that represents one example of control operation for determining transfer bias carried out by a transfer control device;

FIG. 8 is a diagram that represents one example of the sampling voltages when local dirt and heat are generated on a transfer roller;

FIG. 9 is a detailed diagram to explain a vertical cross sectional view that represents a structure example of laser printer as one example of common image forming apparatus;

FIG. 10 is a schematic diagram that represents a variation of sampling voltages when a use environment of a conventional unit is in conditions of a normal temperature and a normal humidity;

FIG. 11 is a schematic diagram that represents a variation of the sampling voltages when a use environment of the conventional unit is in conditions of a high temperature and a high humidity; and

FIG. 12 is a schematic diagram that represents a variation of the sampling voltages when a use environment of the conventional unit is in conditions of a low temperature and a low humidity.

### DETAILED DESCRIPTION

Hereinafter, an embodiment of the present invention will be explained in detail based on the accompanying drawings. Prior to that, the entire structure of an image forming apparatus is outlined by exemplifying a laser printer.

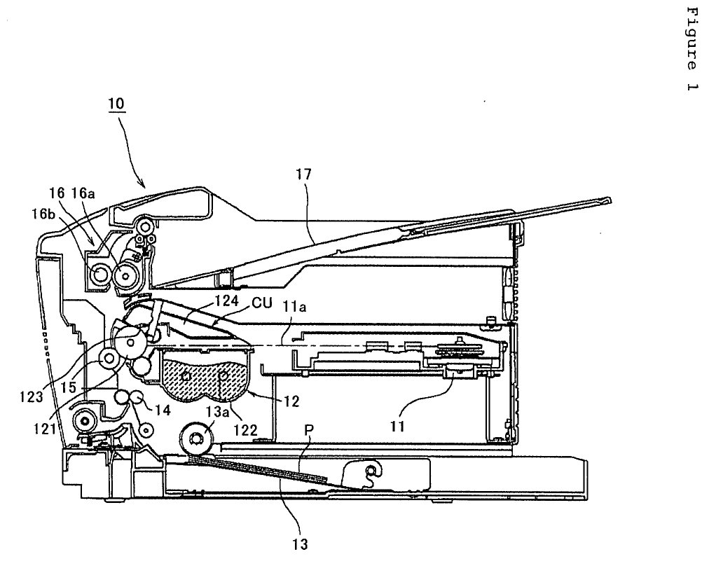

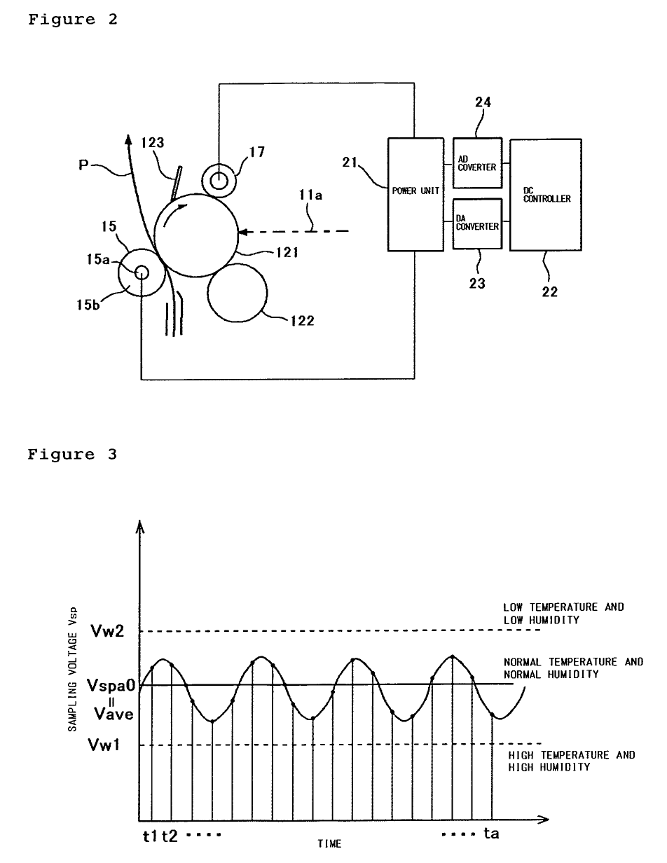

In a laser printer 10 shown in FIG. 1, a piece of image information sent from an outside computer is converted into an image formed in a spot form as light modulation information 11a by a laser emission writing unit 11 via a video controller not shown on a photosensitive drum 121 serving as an image carrier provided inside a process cartridge 12. The light spots are scanned in reciprocating motion in the axis direction (in the main operation direction) of the photosensitive drum 121, thereby forming an electrostatic latent image corresponding to the formed image on the photosensitive drum 121. Further, as shown in FIG. 2, a developing agent (toner) is then supplied from a developing device 122 integrally provided inside the process cartridge 12 to the electrostatic latent image on the photosensitive drum 121, thereby forming an unfixed toner image.

On the other hand, sheets of recording paper P stored in a paper feeder such as a paper feeding cassette 13 is arranged on the lower portion side of the apparatus, and a sheet of the recording paper P inside the paper feeding cassette 13 is drawn out by a paper feeding roller 13a and delivered to a transfer area facing to the photosensitive drum 121 by a resist roller 14 with appropriate timing.

In the transfer area of the photosensitive drum 121, a transfer roller 15 as a contact transfer member is arranged so as to come in contact with the surface of the photosensitive drum 121. The transfer roller 15 of the present embodiment is made such that the outer peripheral side of a core 15a having an eight mm diameter made of stainless (SUS) is covered with a rubber roller 15b having a 16 mm outer diameter made of formed nitrile butadiene rubber (NBR), and the electric resistance thereof measured at the time when a voltage of 2.0 KV is applied while the transfer roller 15 is rotated at a peripheral speed of about 50 mm/sec under a load of about 400 g weight falls within the range of from about 1×10⁸Ω to 5×10⁸Ω. Urethane rubber, silicone rubber, ethylene-propylene rubber (EPR), ethylene propylene diene terpolyner (EPDM), isoprene rubber (IR), or the like can be employed for the rubber roller 15b.

To the transfer roller 15 as such a contact transfer member, a transfer bias that is controlled as described later is applied, and the unfixed toner image on the photosensitive drum 121 is electrostatically transferred onto the recording paper P by the transfer bias. After the transfer, the toner remaining on the photosensitive drum 121 is scraped off the photosensitive drum 121 by a sliding contact force of a cleaning blade 123 arranged so as to press-contact with the surface of the photosensitive drum 121, and the waste toner scraped off by the cleaning blade 123 is stored inside a waste toner housing unit 124 provided to a cleaning unit CU retaining the cleaning blade 123.

Further, the recording paper P carrying the unfixed toner by the transfer action is delivered toward a fixing device 16 arranged at a position immediately above and adjacent to the process cartridge 12. To the fixing device 16, a fixing roller 16a as a heater and a pressing roller 16b are provided. By means of heating fixing action of the fixing roller 16a and the pressing roller 16b, the unfixed toner on the recording paper P is heated and melted, resulting in that a toner image is fused and fixed on the recording paper P. The recording paper P fixed with the toner image by such a heating and fixing action is discharged onto a paper delivery tray 17 arranged in the upper portion of the apparatus.

Here, as particularly shown in FIG. 2, the transfer roller 15 as a contact transfer member is arranged in contact with the transfer area of the photosensitive drum 121 as an image carrier, and a transfer bias output from a power unit 21 serving as a transfer bias applying unit is applied to the core 15a of the transfer roller 15. Particularly in an apparatus that carries out regular development, in order to carry out transfer operation efficiently by the transfer roller 15 as described above, it is also carried out that a primary charging bias is applied to a primary charging roller 17 from the power unit 21 by changing the polarity of the primary charging bias to the same polarity as that of toner, thereby facilitating transfer of toner on the photosensitive drum 121 toward the transfer roller 15 side.

Further, a direct current (DC) controller 22 that structures the transfer control device is connected to the power unit 21 as the transfer bias applying unit via a digital-to-analog (DA) converter 23 and an analog-to-digital (AD) converter 24. By control operation of the DC controller 22 as the transfer control device, a transfer bias compatible with the environment at the time of use is output from the power unit 21 as the transfer bias applying unit in a manner described below.

The control function provided to the DC controller 22 as this transfer control device is specifically explained according to the control procedure. First, the DC controller 22 is provided with a function that passes a constant detection current to the transfer roller 15 from the power unit 21 in a state of no recording paper or in a paper feeding interval and detects a voltage value necessary for passing the constant current, that is, an electric resistance of the transfer roller 15 by sampling. This sampling using a constant detection current with respect to this transfer roller 15 is conducted over one or more rounds of the transfer roller 15. In a state of no recording paper (initial ATVC), sampling is carried out for one rotation of the transfer roller 15. During feeding paper (interpaper ATVC), four times of sampling is carried out for every paper feeding interval. In this way, detection operation with respect to the transfer roller 15 can be not only smoothly carried out without giving disturbance to the image forming operation but also carried out over the whole circumference of the transfer roller 15, and therefore, transfer control operation with high accuracy can be carried out.

Such sampling operation with respect to the transfer roller 15 is carried out to obtain a plurality of sampling voltages Vsp detected at every appropriate micro-time interval t of a few microseconds as shown, for example, in FIG. 3. When the number a of sampling voltages, for example, are obtained, a constant detection current is passed with respect to the transfer roller 15 at every sampling time t1, t2, . . . , or ta. Then, a number of sampling voltages Vsp1, Vsp2, . . . , Vspk, . . . , and Vspa are detected corresponding to each current passing, and an average value Vave (=Σ Vspk/a) of a number of the sampling voltages Vsp1, Vsp2, . . . , Vspk, . . . , and Vspa is computed.

At this time, when a use environment at the current time is in the conditions of a normal temperature and a normal humidity (for example, between 15 degrees C. and 10% humidity and 32 degrees C. and 60% humidity) as shown in FIG. 3, the average detected voltage Vave of a number of the sampling voltages Vsp1, Vsp2, . . . , Vspk, . . . , and Vspa is immediately employed as a representative value Vspa0, and a transfer bias Vo corresponding to the average detected voltage Vave is output from the power unit (transfer bias applying unit) 21 as a transfer bias compatible with the current use environment of normal temperature and normal humidity.

This control operation to compute and determine the transfer bias Vo in the use environment of normal temperature and normal humidity is similar to that of a transfer control device for optimizing transfer bias so-called ATVC control device that is conventionally known. However, in the present invention, in addition to the conventional control operation for transfer bias at the time of such normal temperature and normal humidity, another control operation for transfer bias that employs a computation formula different from one by which a mere average value is computed is carried out as follows when the degree of high temperature and high humidity, or low temperature and low humidity becomes larger.

In other words, in order to judge the use environment at the current time at first, the average detected voltage Vave of a number of the sampling voltages Vsp1, Vsp2, . . . , Vspk, . . . , and Vspa obtained as described above is determined, and the determined average detected voltage Vave is compared with each of two threshold voltages Vw established in advance, that is, a first threshold voltage Vw1 corresponding to the lower limit voltage of a use environment of high temperature and high humidity (for example, 32 degrees C. and 60% or higher humidity) and a second threshold voltage Vw2 corresponding to the upper limit voltage of a use environment of low temperature and low humidity (for example, 15 degrees C. and 10% or lower humidity). When the average detected voltage Vave is lower than the first threshold voltage Vw1, the environment is judged as an environment of low temperature and low humidity, and when the average detected voltage Vave is higher than the second threshold voltage Vw2, the environment is judged as an environment of high temperature and high humidity.

On the other hand, for each of the three environment ranges divided by the two of the first threshold voltage Vw1 and the second threshold voltage Vw2, a predetermined computation formula allocated in advance corresponding to each environment is provided. Any one of the computation formulae is appropriately selected according to the use environment at the current time, and a representative value Vspa1 of the sampling voltages Vsp1, Vsp2, . . . , Vspk, . . . , and Vspa is obtained with respect to the selected computation formula with the use of a number of the sampling voltages Vsp1, Vsp2, . . . , Vspk, . . . , and Vspa.

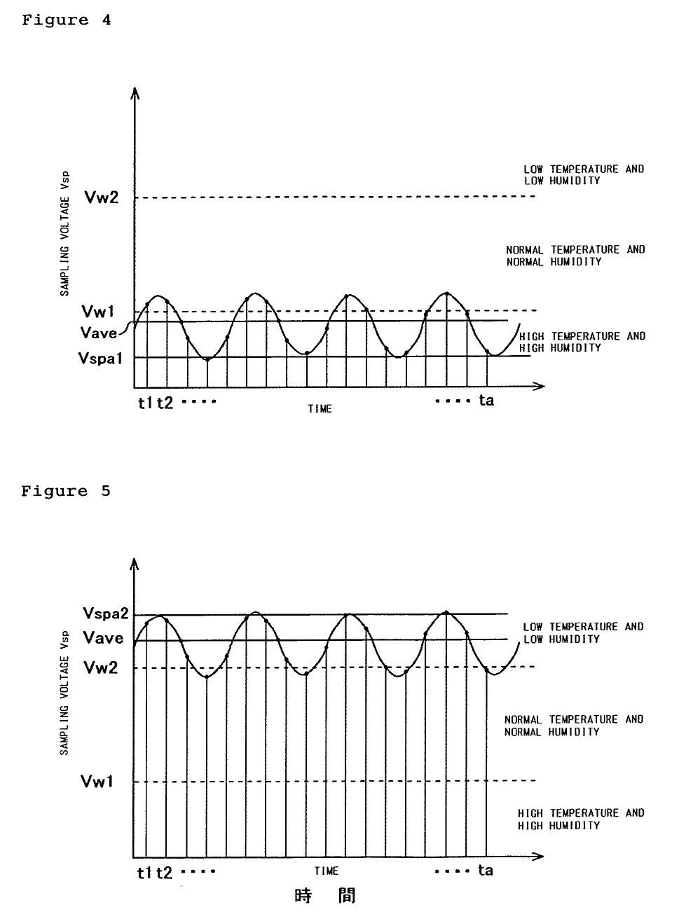

More specifically, a computation formula by which an average value Vave (=ΣVspk/a) similar to that of the above described conventional formula is computed is established for the use environment of normal temperature and normal humidity as shown in FIG. 3 corresponding to the range between the first threshold voltage Vw1 and the second threshold voltage Vw2, and when the average detected voltage Vave falls in the range of high temperature and high humidity that is lower than the first threshold voltage Vw1 as shown in FIG. 4, the following computation formula for high temperature and high humidity by which an average value Vave1 of an arbitrary number n of the sampling voltages definitely selected from the lowest voltage Vspmin of a number of the sampling voltages Vsp1, Vsp2, . . . Vspk, . . . , and Vspa in the ascending order is computed as a representative value Vspa1 is provided.
Vspa1=min(Vsp1, . . . , Vspa)+((n−1) sampling values in ascending order except Vmin)/n (Formula 1)

On the other hand, when the average detected voltage Vave of a number of the sampling voltages Vsp1, Vsp2, . . . Vspk, . . . , and Vspa falls in the range of low temperature and low humidity that is higher than the second threshold voltage Vw2 as shown in FIG. 5, the following computation formula for low temperature and low humidity by which an average value Vave1 of an arbitrary number n of the sampling voltages definitely selected from the highest voltage Vspmax of a number of the sampling voltages Vsp1, Vsp2, . . . Vspk, . . . , and Vspa in the descending order is computed as a representative value Vspa2 is provided.
Vspa2=max(Vsp1, . . . Vspa)+((n−1) sampling values in descending order except Vmax)/n (Formula 2)

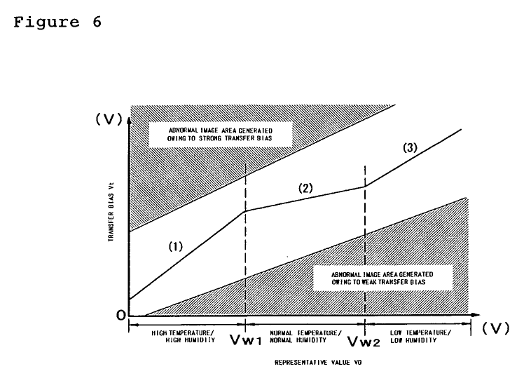

A representative value Vspa1 of a number of the sampling voltages Vsp1, Vsp2, . . . Vspk, . . . , and Vspa is obtained and determined by applying a number of the sampling voltages Vsp1, Vsp2, . . . . Vspk, . . . , and Vspa to any one of these computation formulae. The representative value Vsp1 employed is used, for example, in a control table (control formula) as shown in FIG. 6, thereby determining a transfer bias compatible with a use environment at the current time. The determined transfer bias is allowed to be output from the power unit 21 as the transfer bias applying unit to the transfer roller 15. It should be noted that detailed contents of the control table (control formula) shown in FIG. 6 will be described later.

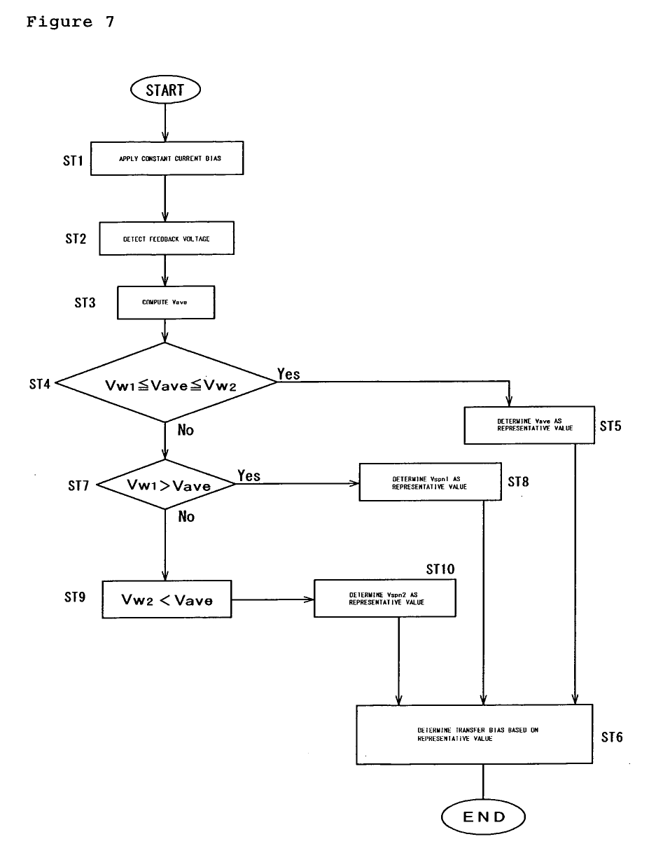

In the DC controller 22 as a transfer control device having such a function according to the present embodiment, transfer control operation such as a transfer bias determination routine shown in FIG. 7, for example, is carried out. In other words, first, a constant detection current is passed to the transfer roller 15 serving as a contact transfer member (step 1), and a number of the sampling voltages Vsp1, Vsp2, . . . , Vspk, . . . , and Vspa are obtained by detecting the feedback voltages at that time (step 2).

Second, an average detected voltage Vave of a number of the sampling voltages Vsp1, Vsp2, . . . , Vspk, . . . , and Vspa is computed (step 3), and the computed average detected voltage Vave is compared with the first threshold voltage Vw1 and the second threshold voltage Vw2. Then, when the average detected voltage Vave falls between the first threshold voltage Vw1 and the second threshold voltage Vw2 and when the current use environment is judged to be within the range of normal temperature and normal humidity (Yes in step 4), in a manner similar to the conventional manner, the average detected voltage Vave of a number of the sampling voltages Vsp1, Vsp2, . . . , Vspk, . . . , and Vspa is determined as the representative value Vspa1 to be employed (step 5), and finally a transfer bias to be output is determined from the data table of FIG. 6 based on the representative value Vspa1 (step 6).

On the other hand, when the use environment falls in conditions of a high temperature and a high humidity, the whole of the sampling voltages Vsp1, Vsp2, . . . , Vspk, . . . , and Vspa falls and their average detected voltage Vave becomes lower than the first threshold voltage Vw1 (Yes in step 7), a representative value Vspa1 is computed so as to take a value lower than the normal average detected voltage Vave with the use of the computation formula for high temperature and high humidity corresponding to the environment of high temperature and high humidity based on the data definitely selected from the plurality of sampling voltages Vsp1, Vsp2, . . . , Vspk, . . . , and Vspa (step 8), and a transfer bias to be output is determined from the control table of FIG. 6 based on the representative value Vapa1 (=Vave1) determined and employed in such a manner (step 6). As the result, a transfer defect in portions with excessive drop (shaded portions in FIG. 11) in the sampling voltages Vsp1, Vsp2, . . . , Vspk . . . , and Vspa is prevented.

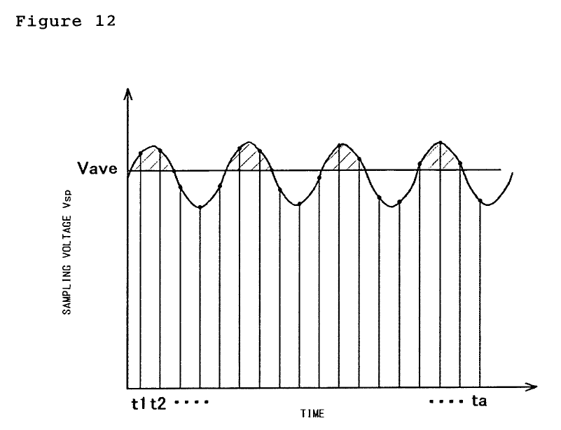

On the contrary, when the use environment falls in conditions of a low temperature and a low humidity, the whole of the sampling voltages Vsp1, Vsp2, . . . , Vspk, . . . , and Vspa rises and their average detected voltage Vave becomes higher than the second threshold voltage Vw2 (Yes in step 9), a representative value Vspa2 is computed so as to take a value higher than the normal average detected voltage Vave with the use of the computation formula for low temperature and low humidity corresponding to the environment of low temperature and low humidity based on the data definitely selected from the plurality of sampling voltages Vsp1, Vsp2, . . . , Vspk, . . . , and Vspa (step 10), and a transfer bias to be output is determined from the control table of FIG. 6 based on the representative value Vapa2 determined and employed in such a manner (step 6). As the result, a transfer defect in portions with excessive rise (shaded portions in FIG. 12) in the sampling voltages Vsp1, Vsp2, . . . , Vspk, . . . , and Vspa is prevented.

Here, the control table described above and shown in FIG. 6 (control formula) is used to determine a transfer bias Vt at the time of transfer of toner to a sheet of recording paper. An appropriate detection current is passed to the photosensitive drum 121 side through the transfer roller 15 in a state of no paper such as during preliminary rotation in an image forming process, and a resistance value of the transfer roller 15 is detected from a voltage Vo (horizontal axis) of feedback voltage value generated at this time, followed by determining the transfer bias Vt (vertical axis) based on the resistance value. The relation between the transfer bias Vt of the vertical axis in FIG. 6 and an output image is correlated with each other in advance by varying the resistance value of the transfer roller in each environment in experiments, and the following control formulae 1 to 3 are designed so as not to enter the abnormal image ranges with shaded portions in FIG. 6.
In the case of V0≦Vw1, Vt=aV0+b (1)
In the case of Vw1<V0≦Vw2, Vt=cV0+d (2)
In the case of Vw2<V0, Vt=eV0+f (3)

That is, a resistance value of the transfer roller is detected before feeding a sheet of recording paper, and control operation is carried out so as to apply an appropriate transfer bias corresponding to the detected resistance value at the time of image formation.

In this way, in the present embodiment, when the average detected voltage Vave of a plurality of the sampling voltages Vsp1, Vsp2, . . . , Vspk, . . . , and Vspa obtained by passing a constant detection current to the transfer roller 15 serving as a contact transfer member falls in a state that the average detected voltage Vave deviates from the range of a threshold voltage Vw owing to the change to a use environment of high temperature and high humidity or low temperature and low humidity, the representative values Vspa1, Vspa2, and Vspa0 of the plurality of sampling voltages Vsp1, Vsp2, . . . , Vspk, . . . , and Vspa can be determined in conditions highly compatible with a use environment by the selective use of a computation formula suitable for the range deviating from the range of the threshold voltages Vw; thereby making it possible to carry out good transfer operation in either environment of high temperature and high humidity or low temperature and low humidity.

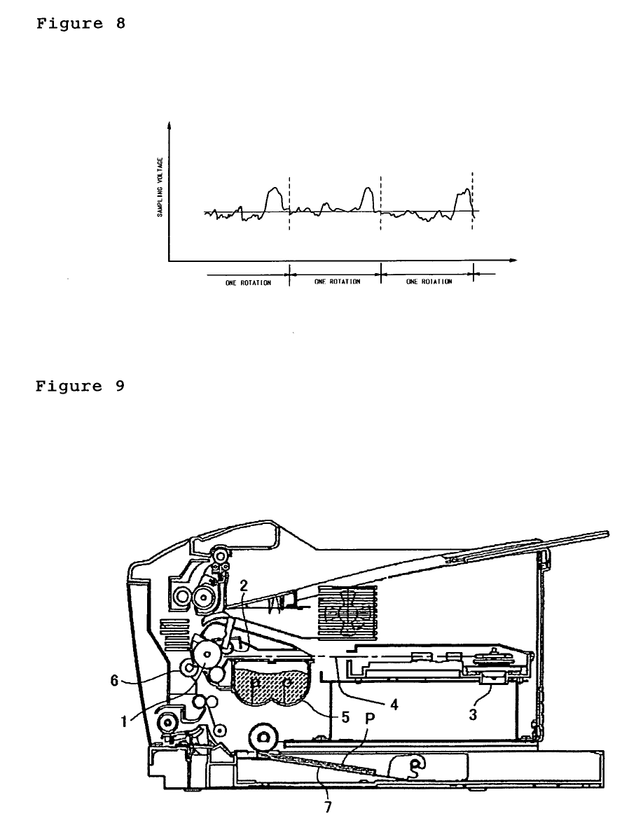

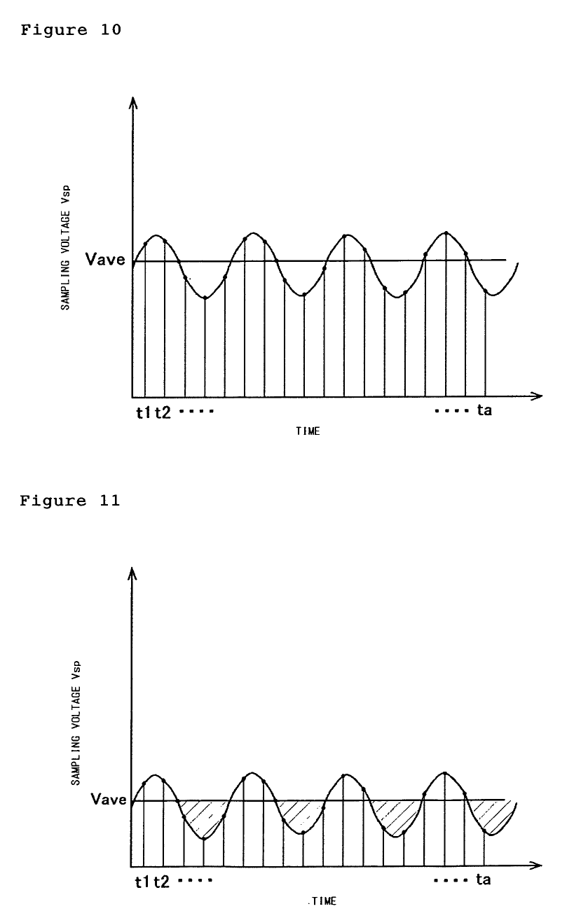

Further, according to the present embodiment, a transfer defect is prevented even when dirt such as toner particles and paper dust adheres to the transfer roller. That is, the dirt often adheres to the transfer roller more locally than uniformly in the peripheral direction. When the conventional ATVC constant current bias is applied in such a state, sampling voltages corresponding to the dirty portions, for example as shown in FIG. 8, become locally high, resulting in an increase in area of transfer defect. When the transfer control according to the present invention is applied in such a case, a transfer bias corresponding to the locally dirty area can be obtained, and as the result, good transfer operation is carried out.

Furthermore, according to the present embodiment, a transfer defect when various heat sources are arranged adjacently to the transfer roller is prevented. In other words, it is often the case that a transfer roller made of ion conductive rubber or the like having a large resistance variation due to environmental change is arranged close to a fixing device or that various heat sources such as a heater for preventing moisture absorption in the apparatus are arranged. In such cases, part of the resistance value of the transfer roller is sometimes changed under the influence of heat from such heat sources resulting in local variations of sampling voltages, thereby leading to an increase in area of a transfer defect similarly to the case of the locally dirty area. When the transfer control according to the present invention is applied in such a case, a transfer bias corresponding to a local resistance variation can be obtained, and as the result good transfer operation is carried out.

Hereinbefore, the invention carried out by the present inventors has been specifically explained based on the embodiment; however, the present invention is not limited to the above embodiment, and moreover, it is needless to say that various modifications are possible without departing from the scope of the present invention.

For example, an average value is computed when a representative value of sampling voltages is determined in the above embodiment. However, it is also possible to determine a representative value by computing a standard deviation or the like.

Still further, the present invention is applied to a laser printer in the above embodiment; however, the present invention is not limited to a laser printer but can be similarly applied to other various image forming apparatuses.

As described above, the transfer control unit of image forming apparatus according to the present invention has a structure in which the representative values Vspa1, Vspa2, and Vspa0 of the plurality of sampling voltages Vsp are obtained corresponding to use environments, and a transfer bias compatible with a use environment at the current time is output from the transfer bias applying unit based on the obtained representative value Vspa1, Vspa2, or Vspa0. By virtue of this structure, the representative value Vspa1, Vspa2, or Vspa0 of the plurality of sampling voltages Vsp can be obtained in conditions highly compatible with a use environment at the current time and good transfer operation can be carried out under either use environment of high temperature and high humidity or low temperature and low humidity. Thus, it is possible to carry out control operation of transfer bias satisfactorily in conditions more compatible with a use environment and enhance the reliability of the image forming apparatus.

What is claimed is:

1. A transfer control unit of image forming apparatus comprising:
an image carrier that retains a toner image formed after development;
a contact transfer member that is arranged so as to come in contact with a transfer area of the image carrier;
a transfer bias applying unit that allows the toner image on the image carrier to be transferred onto the recording paper side by applying a transfer bias to the contact transfer member; and
a transfer control device that computes an average value of a plurality of sampling voltages obtained by passing a constant detection current to the contact transfer member and allows an output of a transfer bias compatible with a use environment at the current time from the transfer bias applying unit based on the average detected voltage,
wherein the transfer control device is structured such that an average detected voltage of all the sampling voltages is employed as a representative value under a constant use environment, whereas an average detected voltage of defined sampling voltages is employed as a representative value under another use environment that deviates from the constant use environment, and the transfer bias applying unit outputs a transfer bias determined based on the representative value employed.

2. The transfer control unit of image forming apparatus according to claim 1, wherein the transfer control device is structured such that the average detected voltage of all the sampling voltages is compared with threshold voltages established in advance corresponding to use environments and the use environment is judged based on the comparison results.

3. The transfer control unit of image forming apparatus according to claim 1, wherein the transfer control device is structured such that the plurality of sampling voltage values Vsp are obtained by passing a constant detection current to the contact transfer member in a state of no recording paper or in a paper feeding interval with respect to the contact transfer member.

4. The transfer control unit of image forming according to claim 1, wherein the transfer control device is structured such that sampling of voltage with respect to the contact transfer member is carried out over one or more rounds of the contact transfer member.

5. The transfer control unit of image forming apparatus according to claim 2, wherein a first threshold voltage Vw1 corresponding to the lower limit voltage of a use environment of high temperature and high humidity and a second threshold voltage Vw2 corresponding to the upper limit voltage of a use environment of low temperature and low humidity are established as threshold voltages Vw in the transfer control device.

6. The transfer control unit of image forming apparatus according to claim 5, wherein the transfer control device is provided with computation formulae by which the representative values are computed, the computation formulae comprising:
a computation formula for high temperature and high humidity by which an average value of an arbitrary number n of the sampling voltages selected from the lowest voltage Vspmin of the plurality of sampling voltages Vsp in ascending order is computed as a representative value Vspa1 when an average detected voltage Vave is lower than the first threshold voltage Vw1;
a computation formula for low temperature and low humidity by which an average value of an arbitrary number n of the sampling voltages selected from the highest voltage Vspmax of the plurality of sampling voltages Vsp in descending order is computed as a representative value Vspa2 when the average detected voltage Vave is higher than the second threshold voltage Vw2; and
a computation formula for environment of normal temperature and normal humidity by which an average value Vave of all the plurality of sampling voltages Vsp is computed as a representative value Vspa0 when the average detected voltage Vave falls between the first threshold voltage Vw1 and the second threshold voltage Vw2.
